(19) United States
(12) Patent Application Publication
(10) Pub. No.: US 2013/0241433 A1
(43) Pub. Date: Sep. 19, 2013

(54) METHOD, APPARATUS AND SYSTEM FOR CONTROLLING LIGHT SOURCE

(71) Applicants: Liang'an Ge, Hangzhou (CN); Guichao Hua, Hangzhou (CN); Xiaoli Yao, Hangzhou (CN); Lijun Ren, Hangzhou (CN)

(72) Inventors: Liang'an Ge, Hangzhou (CN); Guichao Hua, Hangzhou (CN); Xiaoli Yao, Hangzhou (CN); Lijun Ren, Hangzhou (CN)

(73) Assignee: INVENTRONICS (HANGZHOU), INC., Hangzhou, Zhejiang (CN)

(21) Appl. No.: 13/881,294

(22) PCT Filed: Aug. 23, 2011
(86) PCT No.: PCT/CN11/78750

§ 371 Date: Apr. 24, 2013

(30) Foreign Application Priority Data
Oct. 28, 2010 (CN) 201010523859.2

(51) Int. Cl. H05B 37/02

(52) U.S. Cl. CPC H05B 37/02
USPC 315/224

(57) ABSTRACT

Provided are a method, apparatus and system for controlling a light source. The method comprises: acquiring an adjustment signal and determining a dimming item according to the adjustment signal; the dimming item being composed of the value and/or value range of at least one characteristics parameter of a pulse drive signal; converting the adjustment signal into the pulse drive signal indicated by the dimming item; controlling an adjustment switch by means of the pulse drive signal, so as to output a voltage including a chopped wave voltage corresponding to the dimming item, thereby transmitting adjustment information about the colour and/or brightness of the light source by means of the voltage including the chopped wave voltage. The method, apparatus and system can achieve the function of adjusting the colour and/or brightness of the light source.

This application claims the priority of Chinese patent application No. 201010523859.2, titled “METHOD, APPARATUS AND SYSTEM FOR CONTROLLING LIGHT SOURCE” and filed with the State Intellectual Property Office on Oct. 28, 2010, which is hereby incorporated by reference in its entirety.

### FIELD OF THE INVENTION

The present invention relates to the field of control, and in particular to a method, an apparatus and a system for controlling a light source.

### BACKGROUND OF THE INVENTION

In the field of lighting, brightness or color of a light source needs to be adjusted on various occasions, which requires the lighting system to be provided with an adjustment function.

Currently, one of the popular techniques is chopping-based light adjusting. FIG. 1 illustrates the circuit structure of a light source adjustor, including a bidirectional trigger diode D1 used as an adjusting switch, and a trigger circuit consisting of an adjustable resistor R1 and a first capacitor C1.

The operating principle of the light source adjustor is described as follows. The output voltage V1 of the light source adjustor is an alternating current (AC) power supply voltage when the bidirectional trigger diode D1 is turned on; the output voltage V1 of the light source adjustor is zero when the bidirectional trigger diode D1 is turned off. The first capacitor C1 is charged through the adjustable resistor R1; and when the voltage across the first capacitor C1 rises to the threshold voltage of the bidirectional trigger diode D1, the bidirectional trigger diode D1 is turned on. Therefore, changing the resistance of the adjustable resistor R1 will change the charging time of the first capacitor C1; then, the change of the charging time will change the conducting angle of the bidirectional trigger diode D1, which is reflected by the output voltage V1 of the light source adjustor, resulting in a chopped voltage such as the leading-edge chopped voltage. The chopped voltage is outputted to a subsequent driver for driving a light source, and the brightness of the light source is adjusted via the driver.

The chopping-based light adjusting technique described above can only adjust the brightness of a light source in a hardware manner, but cannot realize other adjustment functions at the same time such as changing the color of the light source in a, e.g., colored lighting system.

### SUMMARY OF THE INVENTION

In view of the above, a technical problem to be solved by the invention is to provide a method, an apparatus and a system for controlling a light source, which can achieve the adjustment of, e.g., color and/or brightness, of the light source.

Therefore, the following technical solutions are provided by the embodiments of the present invention.

According to an embodiment of the present invention, it is provided a method for controlling a light source, including:
acquiring an adjusting signal and determining a light-adjusting item according to the adjusting signal, where the light-adjusting item consists of a value and/or a value range of at least one characteristic parameter of a pulse driving signal;
converting the adjusting signal into the pulse driving signal indicated by the light-adjusting item; and
controlling an adjusting switch by the pulse driving signal, to output a voltage containing a chopped voltage that corresponds to the light-adjusting item, thereby transferring adjustment information of color and/or brightness of the light source by means of the voltage containing the chopped voltage.

The characteristic parameter includes: duty cycle, frequency, duration of high-level and duration of low-level.

The determining a light-adjusting item according to the adjusting signal includes:
presetting a correspondence relationship between the adjusting signal and the light-adjusting item; and
searching the correspondence relationship according to the adjusting signal, to obtain the light-adjusting item corresponding to the adjusting signal.

The converting the adjusting signal into the pulse driving signal indicated by the light-adjusting item includes:
converting the adjusting signal into the pulse driving signal indicated by the light-adjusting item directly according to the light-adjusting item; or
converting the adjusting signal into a direct current (DC) pulse signal, and converting the DC pulse signal into the pulse driving signal indicated by the light-adjusting item.

The controlling an adjusting switch includes: performing chopping control on the adjusting switch during a time period t1 within a time period t2 after acquiring the adjusting signal, where t1 is smaller than or equal to t2, t1 is greater than or equal to 1/f, f is switching frequency of the adjusting switch, and t2 is a time interval between acquiring the current adjusting signal and acquiring the next adjusting signal.

The method further includes:
controlling the adjusting switch to be in a turn-on state during the rest of the time period t2, other than the time period t1, since the adjusting signal is acquired.

According to the invention, it is provided another method for controlling a light source, including:
receiving electric energy containing a chopped voltage, and detecting a preset characteristic parameter of the chopped voltage;
determining a light-adjusting item according to a value and/or a value range of the characteristic parameter, where the light-adjusting item consists of a value and/or a value range of at least one characteristic parameter of a pulse driving signal; and
determining a light source control strategy according to the light-adjusting item, so as to control color and/or brightness of the light source as indicated by the light source control strategy.

The preset characteristic parameter is the same as the characteristic parameter in the light-adjusting item.

The determining a light source control strategy according to the light-adjusting item so as to control color and/or brightness of the light source as indicated by the light source control strategy includes:
determining the light source control strategy according to the light-adjusting item;
generating a corresponding control signal according to a target current value contained in the light source control strategy; and
inputting the control signal to a light source controller, so that the light source controller adjusts, according to the control signal, current that is outputted from the light source controller itself to each light source, to output the corresponding target current value, thereby achieving the adjustment of the color and/or brightness of the light source.

According to an embodiment of the invention, it is also provided an apparatus for controlling a light source, including:
a first determining unit, configured to acquire an adjusting signal and determine a light-adjusting item according to the adjusting signal, where the light-adjusting item consists of a value and/or a value range of at least one characteristic parameter of a pulse driving signal;
a conversion unit, configured to convert the adjusting signal into the pulse driving signal indicated by the light-adjusting item; and
an output unit, configured to control an adjusting switch by the pulse driving signal, to output a voltage containing a chopped voltage that corresponds to the light-adjusting item, thereby transferring adjustment information of color and/or brightness of the light source by means of the voltage containing the chopped voltage.

The characteristic parameter includes: duty cycle, frequency, duration of high-level and duration of low-level.

The first determining unit includes:
a presetting sub-unit, configured to preset a correspondence relationship between the adjusting signal and the light-adjusting item; and
a searching sub-unit, configured to search the correspondence relationship according to the adjusting signal, to obtain the light-adjusting item corresponding to the adjusting signal.

The conversion unit is configured to:
convert the adjusting signal into the corresponding pulse driving signal directly according to the light-adjusting item; or
convert the adjusting signal into a DC pulse signal, and convert the DC pulse signal into the corresponding pulse driving signal according to the light-adjusting item.

According to an embodiment of the invention, it is further provided an apparatus for controlling a light source, including:
a detecting unit, configured to receive electric energy containing a chopped voltage, and detect a preset characteristic parameter of the chopped voltage;
a second determining unit, configured to determine a light-adjusting item according to a value and/or a value range of the characteristic parameter, where the light-adjusting item consists of a value and/or a value range of at least one characteristic parameter of a pulse driving signal; and
a control unit, configured to determine a light source control strategy according to the light-adjusting item, so as to control color and/or brightness of the light source as indicated by the light source control strategy.

The control unit includes:
a determining sub-unit, configured to determine the light source control strategy according to the light-adjusting item;
a generating sub-unit, configured to generate a corresponding control signal according to a target current value contained in the light source control strategy; and
a transferring sub-unit, configured to input the control signal to a light source controller, so that the light source controller adjusts, according to the control signal, current that is outputted from the light source controller itself to each light source, to output the corresponding target current value, thereby achieving the adjustment of the color and/or brightness of the light source.

According to an embodiment of the invention, it is further provided a system for controlling a light source, including:
an adjusting switch controller, configured to acquire an adjusting signal and determine a light-adjusting item according to the adjusting signal, where the light-adjusting item consists of a value and/or a value range of at least one characteristic parameter of a pulse driving signal; convert the adjusting signal into a pulse driving signal indicated by the light-adjusting item; and control an adjusting switch by the pulse driving signal, to output a voltage containing a chopped voltage that corresponds to the light-adjusting item, thereby transferring adjustment information of color and/or brightness of the light source by means of the voltage containing the chopped voltage; and
a light source driver, configured to receive electric energy containing the chopped voltage and detect a preset characteristic parameter of the chopped voltage; determine the light-adjusting item according to the value and/or the value range of the characteristic parameter, where the light-adjusting item consists of the value and/or the value range of at least one characteristic parameter of the pulse driving signal; determine a light source control strategy according to the light-adjusting item, so as to control the color and/or brightness of the light source as indicated by the light source control strategy.

The technical effect of the above technical solution is as follows.

The corresponding light-adjusting item is determined according to the adjusting signal, and the adjusting signal is converted into the pulse driving signal indicated by the light-adjusting item; the adjusting switch is controlled by the pulse driving signal, so that the adjusting switch controller outputs a voltage containing a chopped voltage that corresponds to the light-adjusting item; and the indication of the light-adjusting item is provided to the light source driver by means of the chopped voltage, so that the light source driver controls the color and/or brightness of the light source as indicated by the light-adjusting item.

### BRIEF DESCRIPTION OF THE DRAWINGS

FIG. 1 is a structural diagram of a circuit of a light source adjustor in the prior art;

FIG. 1a is a schematic structural diagram of a system for controlling a light source according to an embodiment of the invention;

FIG. 1b is a schematic diagram of a chopped voltage that is outputted under a first control mode of an adjusting switch according to the invention;

FIG. 1c is a schematic diagram of a chopped voltage that is outputted under a second control mode of an adjusting switch according to the invention;

FIG. 2 is a schematic diagram of a flow of a method for controlling a light source according to an embodiment of the invention;

FIG. 3 is a schematic diagram of a flow of a method for controlling a light source according to an embodiment of the invention;

FIGS. 3a-3g are examples of structures of the light source according to embodiments of the invention;

FIG. 3h is an example of a structure of a system for controlling a light source in a case that a holding circuit exists according to an embodiment of the invention;

FIG. 3i is an example of a structure of a light source module in a cast that a holding circuit exists according to an embodiment of the invention;

FIG. 4 is a schematic structural diagram of an apparatus for controlling a light source according to an embodiment of the invention;

FIG. 5 is a schematic structural diagram of another apparatus for controlling a light source according to an embodiment of the invention; and

FIG. 6 is a schematic structural diagram of a system for controlling a light source according to an embodiment of the invention.

### DETAILED DESCRIPTION OF THE INVENTION

Implementations of the method, apparatus and system for controlling the light source will be described in detail below in conjunction with the accompanying drawings.

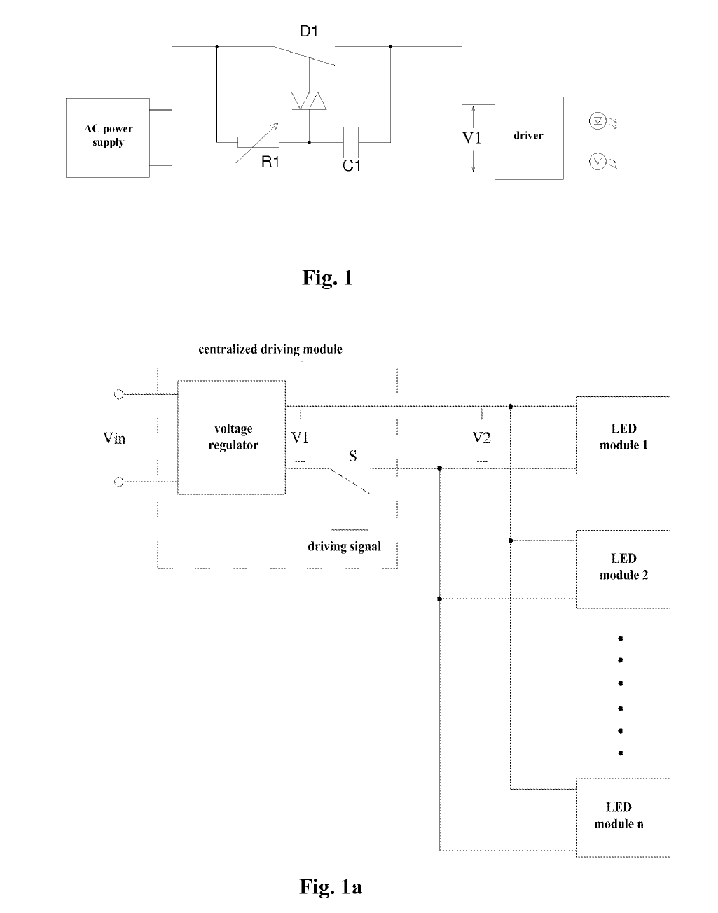

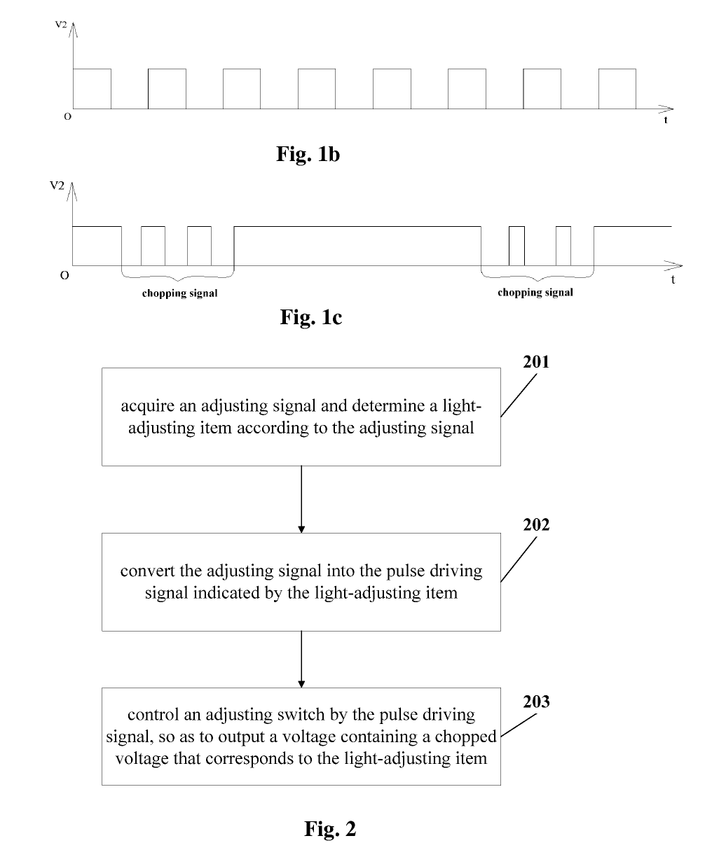

The method for controlling the light source according to the embodiment of the invention is applicable to the light source adjusting system shown in FIG. 1a. The structure of the system includes:
a centralized driving module and at least one light source module connected with the centralized driving module. The light source module may be LED modules shown in FIG. 1a or other light source modules. The centralized driving module includes a voltage regulator and an adjusting switch S connected in series with an output terminal of the voltage regulator. The adjusting switch S operates in a turn-on state or a turn-off state (i.e., a chopping state) under the control of an adjusting switch controller, so that the voltage outputted to the followed light source modules (such as the LED modules) is a chopped voltage. By controlling the duration of the turn-on state and the duration of the turn-off state of the adjusting switch, the voltage outputted to the light source module (such as the LED modules) is a chopped voltage with a corresponding characteristic parameter. Here, the voltage outputted from the voltage regulator is a DC voltage, and the chopped voltage is a pulse DC voltage. The followed LED module includes a light source unit and a light source driver for controlling the light source unit. The light source driver detects the chopped voltage and accordingly performs an adjusting process on the light source in the light source unit. The light source unit receives the chopped voltage and uses it as the inputted electric energy. It can be seen from FIG. 1a that, in the present invention, two wires, between the centralized driving module and the followed light source module, are used for transferring the electric energy as well as the adjustment information, and additional wires for transferring the adjusting signal are unnecessary. The centralized driving module and the followed light source module may be packaged separately, and also, two wires are required between the two packages, without the need of additional wires for transferring the adjusting signal.

FIG. 2 is a schematic diagram of a flow of a method for controlling a light source according to an embodiment of the invention, the method for controlling the light source is applicable to the adjusting switch controller, for controlling the adjusting switch in the centralized driving module. As shown in FIG. 2, the method includes:
Step 201: acquiring an adjusting signal and determining a light-adjusting item according to the adjusting signal;
Step 202: converting the adjusting signal into a pulse driving signal indicated by the light-adjusting item; and
Step 203: controlling the adjusting switch by the pulse driving signal, to output a voltage containing a chopped voltage that corresponds to the light-adjusting item, thereby transferring adjustment information of color and/or brightness of the light source by means of the voltage containing the chopped voltage.

In the method for controlling the light source shown in FIG. 2, a corresponding light-adjusting item is determined according to the adjusting signal, and the adjusting signal is converted into the pulse driving signal indicated by the light-adjusting item; the adjusting switch is controlled by the pulse driving signal, so that the centralized driving module outputs a voltage containing a chopped voltage that corresponds to the light-adjusting item; and the indication of the light-adjusting item is provided to the followed light source module by the chopped voltage, so that the light source module controls the color and/or brightness of the light source as indicated by the light-adjusting item.

It should be noted that, the color of the light source mentioned herein is color in a broad sense, that is, it includes various colors such as red (R), green (G), blue (B) and orange, and also includes various color temperatures such as cold white, warm white and pure white.

Based on FIG. 2, implementations of various steps in the method for controlling the light source according to the embodiment of the invention are described in detail.

For the Step 201:

Generally, an adjustment instruction is inputted by an adjustment operation of a user, and a corresponding adjusting signal is generated by an adjusting signal generating circuit according to the adjustment instruction inputted by the adjustment operation of the user.

The adjusting signal generating circuit may include a brightness adjusting knob and/or a color adjusting knob. The brightness adjusting knob and the color adjusting knob respectively generate the adjusting signal for adjusting the brightness and the adjusting signal for adjusting the color, which form the adjusting signal. Or, the adjusting signal generating circuit may be implemented by a light-adjusting device such as a remote controller, and by operating the light-adjusting device by the user, an adjusting signal is generated by the light-adjusting device. Or, the adjusting signal may be acquired by a digital controller, and the adjusting signal needed to be outputted is determined by a program inputted into the digital controller by the user. Or, the adjusting signal may be implemented by a standard interface signal of the light-adjusting system such as DALI, DMX, and the detailed description thereof is omitted herein.

The adjusting signal generated by the adjusting signal generating circuit corresponds to a brightness adjusting instruction and/or a color adjusting instruction inputted by the user. For example, if the outputted adjusting signal is a level signal having a range of 1V-10V, it is set that the brightness adjustment is indicated in a case that the adjusting signal is a level signal of 1V-5V, and the color adjustment is indicated in a case that the adjusting signal is a level signal of 5V-10V. The adjusting signal may also be a digital signal, and the brightness adjustment and the color adjustment are distinguished by different digital signals, the detailed description thereof is omitted herein.

In a specific implementation, different light-adjusting items may be preset, and there is a correspondence relationship between the light-adjusting items and the adjusting signals corresponding to different light-adjusting instructions, thus in this step, the light-adjusting item corresponding to the adjusting signal may be obtained by searching the correspondence relationship according to the generated adjusting signal directly.

According to an embodiment of the invention, the light-adjusting item may consist of a value and/or a value range of at least one characteristic parameter of the pulse driving signal.

For example, the adjusting signals are classified, according to the color and/or brightness adjustment, into three types, i.e., signals of 1-3V, 4-6V, 7-10V, and the three types of adjusting signals respectively correspond to three light-adjusting instructions which are used for adjusting the brightness, adjusting the color and adjusting the color and the brightness. The light-adjusting items are classified into light-adjusting items 1, 2, 3, the brightness adjustment corresponds to the light-adjusting item 1, the color adjustment corresponds to the light-adjusting item 2, and the brightness and color adjustment corresponds to the light-adjusting item 3. It is preset that the adjusting signal of 1-3V corresponds to the light-adjusting item 1, the adjusting signal of 4-6V corresponds to the light-adjusting item 2, and the adjusting signal of 7-10V corresponds to the light-adjusting item 3. Therefore, in a specific implementation, the corresponding light-adjusting item may be searched out according to the amplitude of the received adjusting signal.

For the Step 202:

The characteristic parameter in the light-adjusting item may include for example, duty cycle, frequency, duration of high-level, duration of low-level.

For example, in a specific implementation, the light-adjusting item may be classified according to different values and/or value ranges of a characteristic parameter. For example, the light-adjusting item consists of different values and/or value ranges of the duty cycle, specifically, it is set that the duty cycle of 10%-30% corresponds to the light-adjusting item 1, the duty cycle of 40%-60% corresponds to the light-adjusting item 2, and the duty cycle of 70%-90% corresponds to the light-adjusting item 3.

Or, the light-adjusting item may be classified according to different values and/or value ranges of two or more characteristic parameters. For example, the light-adjusting item is classified according to different values and/or value ranges of the frequency and the duty cycle. Or, it may be set that different values and/or value ranges of the frequency are used for the color adjustment, and different values and/or value ranges of the duty cycle are used for the brightness adjustment.

Furthermore, there may be multiple levels for the adjustment of the color and/or brightness, therefore, the number of the light-adjusting items may be set as required, and the values and/or value ranges of the characteristic parameter may be divided reasonably.

For example, according to the above two examples, the color adjustment corresponds to the light-adjusting item 2, and the light-adjusting item 2 consists of duty cycle of 10%-30%, then if different levels are set for the color adjustment, i.e., a light-adjusting item 21, a light-adjusting item 22 and a light-adjusting item 23 which respectively represent colors of red, green and blue are set on the basis of the light-adjusting item 2, the duty cycle of 10%-30% may be divided into three ranges, which respectively represent the light-adjusting item 21, the light-adjusting item 22 and the light-adjusting item 23.

Furthermore, there are two cases for the implementation of this step according to the implementation of the adjusting signal.

A first case: if the adjusting signal is a DC pulse signal, the implementation of this step may include:
converting the adjusting signal into a corresponding pulse driving signal directly according to the light-adjusting item.

A second case: if the adjusting signal is not a DC pulse signal, the implementation of this step may include:
converting the adjusting signal into a DC pulse signal; and
converting the DC pulse signal into a corresponding pulse driving signal according to the light-adjusting item.

For example, according to the above example, if the adjusting signal is a level signal of 1V-3V, the level signal of 1V-3V is required to be converted into a pulse driving signal corresponding to duty cycle of 10%-30%, for controlling the adjusting switch; and the level signal of 4V-6V is converted into a pulse driving signal corresponding to duty cycle of 40%-60%.

For the Step 203:

The controlling the adjusting switch includes the following ways.

A first way: outputting the chopped voltage at all times, as shown in FIG. 1b.

A second way: performing chopping control on the adjusting switch during a time period t1 within a time period t2 after acquiring the adjusting signal, where t1 is smaller than t2, t1 is greater than 1/f, f is switching frequency of the adjusting switch, and t2 is the time interval between acquiring the current adjusting signal and acquiring the next adjusting signal. The adjusting switch is controlled to be in a turn-on state during the rest of the time period t2, other than the time period t1, since the adjusting signal is acquired, as shown in FIG. 1c.

The chopping control means generating, during the time period t1, a pulse driving signal which is used for performing chopping control and corresponds to the adjusting signal, and generating, in other time period, a driving signal which causes the adjusting switch to be turned on.

Furthermore, it is preferable that t1 is less than t2, or even far less than t2. This is because that, for the centralized driving module and the light source module, the light-adjusting instruction is successfully transferred as long as the chopped voltage outputted from the centralized driving module is received and the characteristic parameter of the chopped voltage is detected by the light source module. If t1 is equal to t2, the light-adjusting instruction may also be successfully transferred, but electromagnetic interference may occur since the centralized driving module continuously outputs the chopped voltage when the brightness of the light source is adjusted as in the prior art. Therefore, the electromagnetic interference can be decreased by outputting the chopped voltage only in the time period t1 which is within the time period t2.

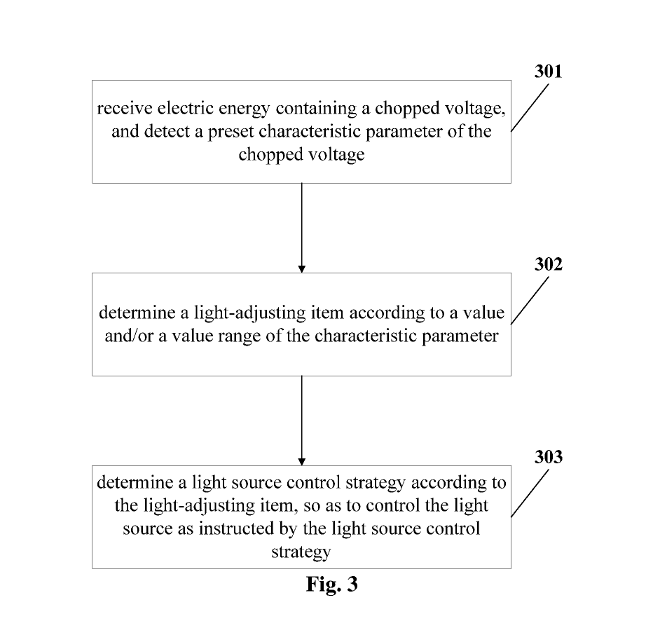

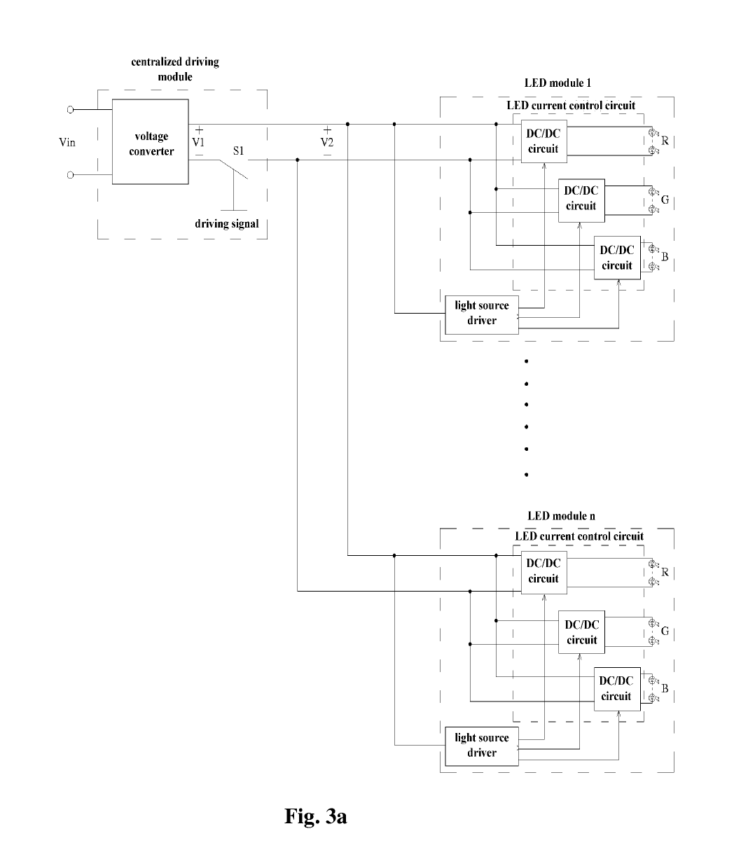

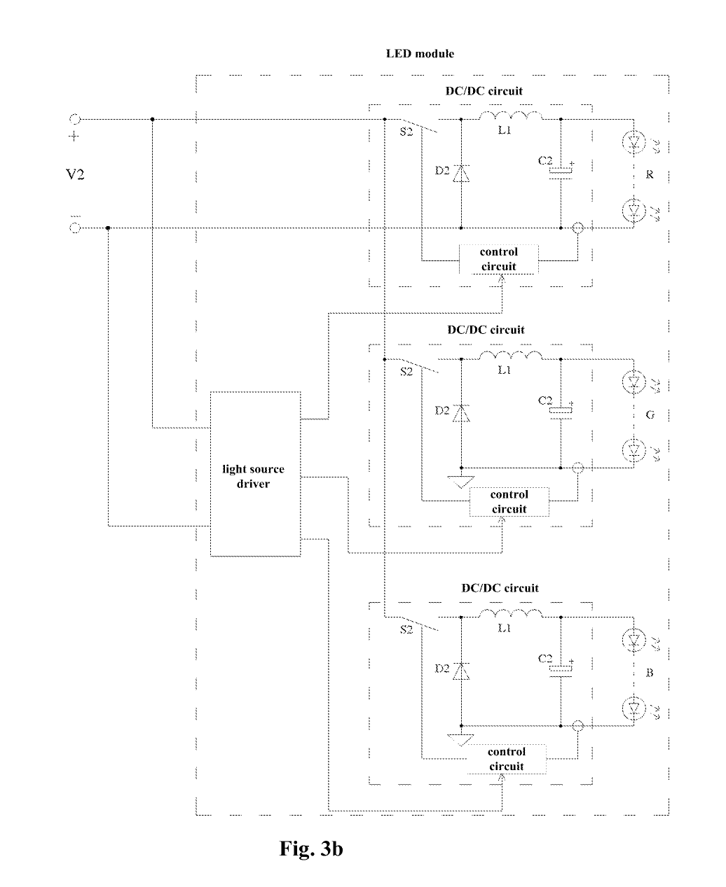

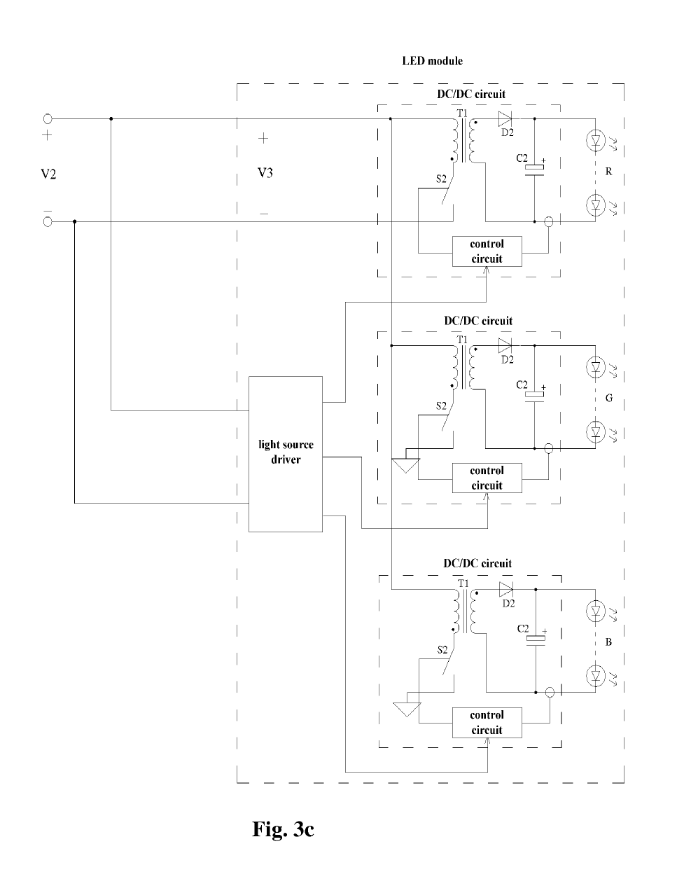

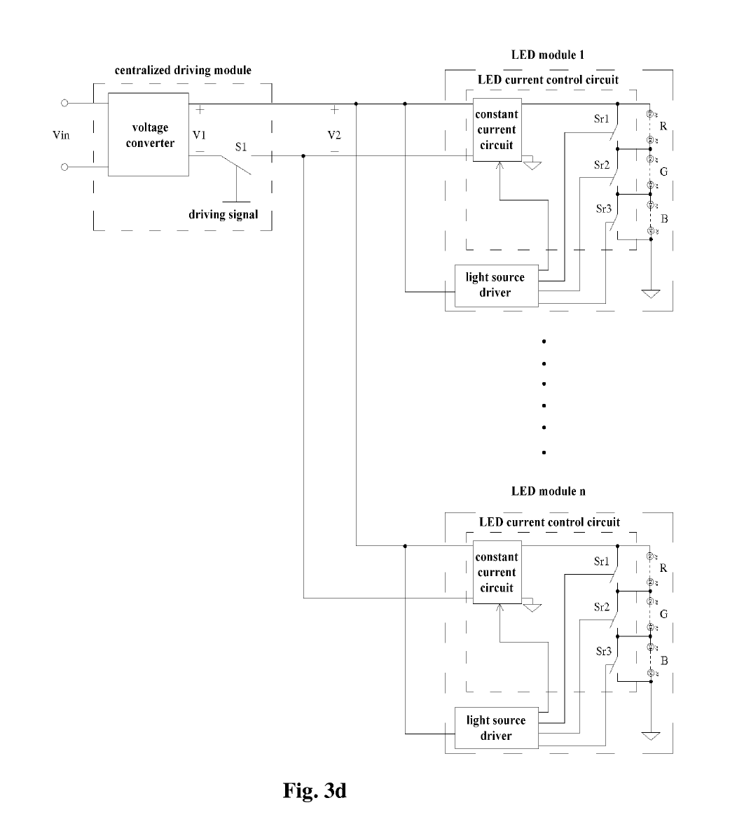

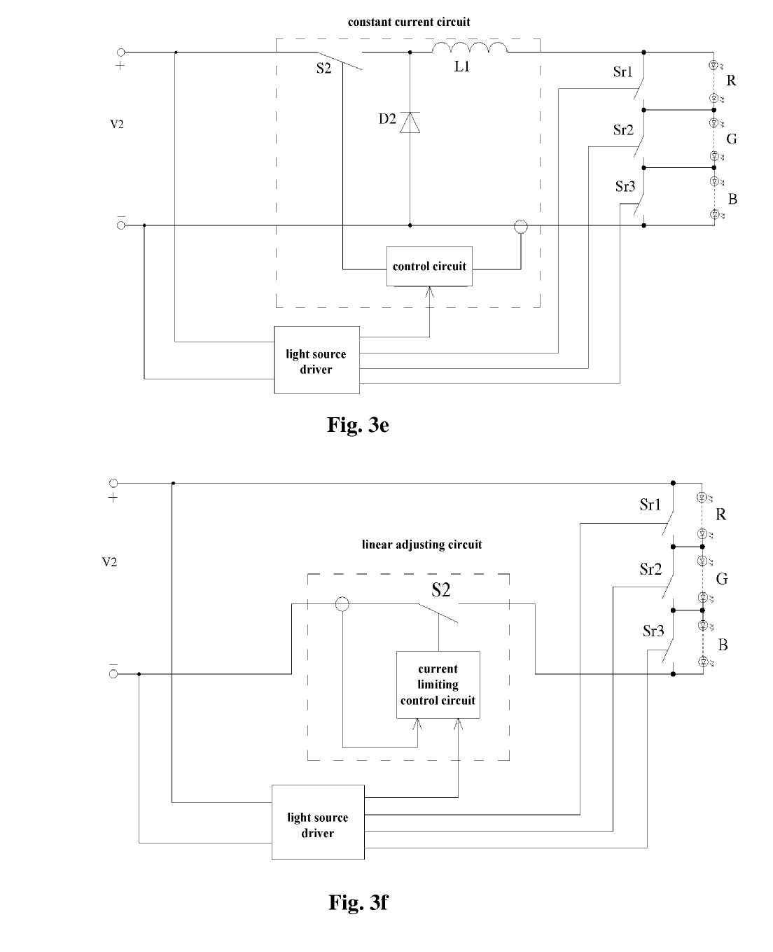

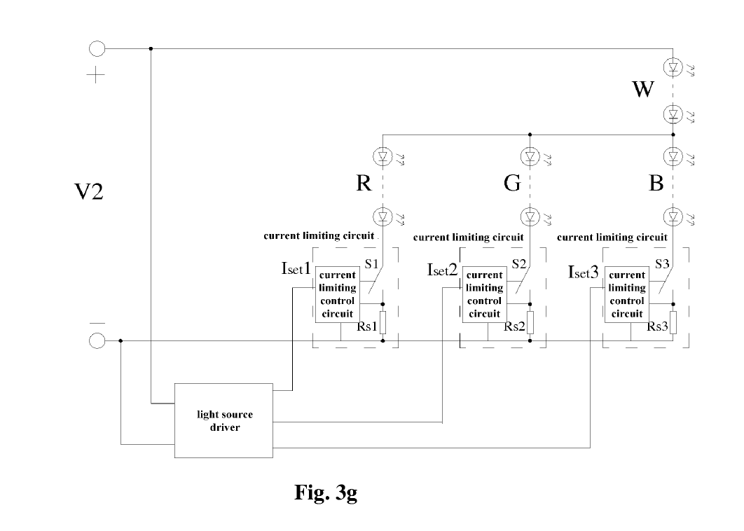

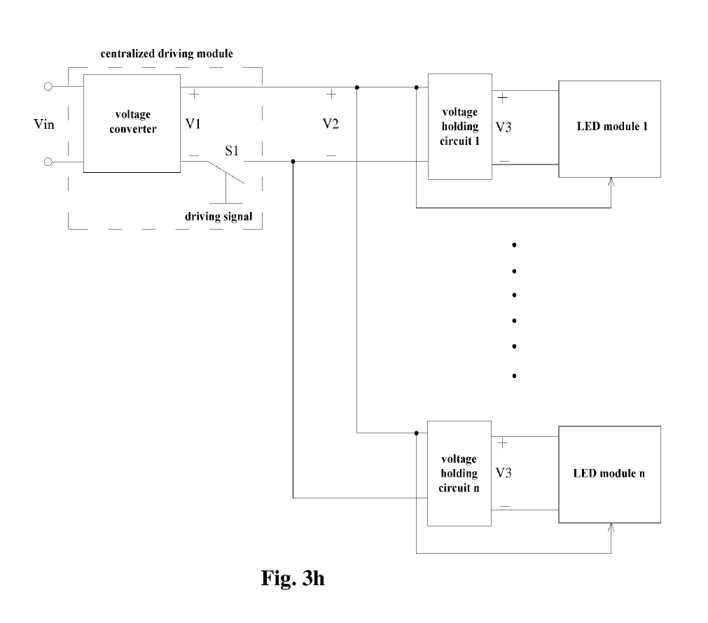

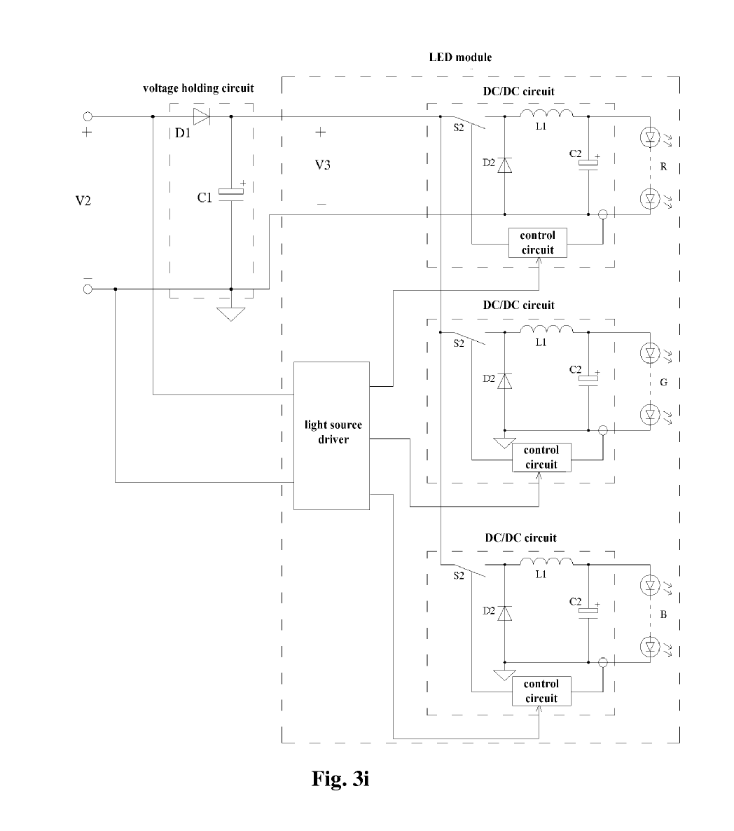

Corresponding to the method for controlling the light source that is shown in FIG. 2, another method for controlling a light source is provided by an embodiment of the invention, and the method is used in a light source driver in the light source module which is used for performing driving control on the light source unit. As shown in FIG. 3, the method includes the following steps:
Step 301: receiving electric energy containing a chopped voltage, and detecting a preset characteristic parameter of the chopped voltage;
Step 302: determining a light-adjusting item according to a value and/or a value range of the characteristic parameter;
Step 303: determining a light source control strategy according to the light-adjusting item, so as to control color and/or brightness of the light source as indicated by the light source control strategy.

In the embodiment of the invention that is shown in FIG. 3, electric energy containing a chopped voltage is received and a preset characteristic parameter of the chopped voltage is detected; a light-adjusting item is determined according to the value and/or the value range of the characteristic parameter; and a light source control strategy is determined according to the light-adjusting item, so as to control color and/or brightness of the light source as indicated by the light source control strategy. Therefore, the light source driver may identify the light-adjusting item according to the chopped voltage, and the control of the color and/or brightness of the light source in the light source unit is achieved.

For the Step 301:

The preset characteristic parameter is determined according to the characteristic parameters contained in the light-adjusting item. For example, if the light-adjusting item consists of the value and/or value range of the duty cycle, the preset characteristic parameter is the duty cycle; or, if the light-adjusting item consists of the frequency and the duration of high-level, the preset characteristic parameter is the frequency and the duration of high-level. That is, the corresponding light-adjusting item is determined upon detection of the preset characteristic parameter.

For the Step 302:

The various light-adjusting items can be determined according to the specific value of the preset characteristic parameter detected in the step 301, so as to obtain the light-adjusting item that the specific value of the preset characteristic parameter belongs to.

Here, the preset light-adjusting items in the light source driver should be the same as the preset light-adjusting items in the corresponding centralized driving module, so as to ensure that the light source driver adjusts the light source according to the light-adjusting instruction of the centralized driving module.

For example, according to the above example, if it is detected that the duty cycle is in the range of 10%-30%, it can be determined that the corresponding light-adjusting item is the light-adjusting item 1, and the light-adjusting item 1 corresponds to the brightness adjustment of the light source. Accordingly, in the step 303, the light source is adjusted according to the specific adjustment instruction corresponding to the light-adjusting item 1.

For the Step 303:

In this step, correspondence relationship between different light-adjusting items and light source control strategies may be preset. Therefore, the light source control strategy can be determined according to the light-adjusting item.

The light source control strategy corresponds to the adjustment instruction described above. For example, the light source control strategy may include: the adjustment of the brightness and/or color of the light source; and may also include: levels of the adjustment of the brightness and/or color of the light source.

In general, different light source control strategies may be preset to different target current values, thus this step may be implemented as follows:
determining the light source control strategy according to the light-adjusting item;
generating a corresponding control signal according to the target current value contained in the light source control strategy; and
inputting the control signal to the light source controller, so that the light source controller adjusts, according to the control signal, the current that is outputted from the light source controller itself to each light source, to output the corresponding target current value, thereby achieving the adjustment of the color and/or brightness of the light source.

Furthermore, the control method in this step may be different if the structure of the light source to be controlled is different, and the main difference is that the signal outputted to the light source or the light source controller is different.

Hereinafter, as an example, it is provided that the light source module is an LED module, and the color and/or brightness control in this step is described in detail.

(1) The structure of the LED module includes LED lamps of same color or LED lamps of at least two colors, the LED lamps of each color correspond to a DC/DC circuit, the DC/DC circuit forms the LED current control circuit (i.e., the light source controller) for controlling the color and/or brightness of the LED lamps of each color by the current, and the DC/DC circuit is controlled by the output signal of the light source driver.

For example, in the structure of the light source shown in FIG. 3a, a LED module includes lamps of three colors, i.e., red (R) lamps, green (G) lamps and blue (B) lamps, and three DC/DC circuits which respectively control the currents of the R lamps, G lamps and B lamps.

Specifically, the light source driver generates a corresponding control signal for the DC/DC circuit according to the light source control strategy, such as current corresponding to a certain light source control strategy. The DC/DC circuit controls each branch of the LED lamps according to the inputted control signal, for example, the control signal controls the current reference signal or feedback signal of the DC/DC circuit, changes the current of each branch of LED lamps, and thereby changes the brightness or color of the LED module.

FIG. 3b is a specific implementation based on FIG. 3a. In FIG. 3b, the DC/DC circuit is implemented by a BUCK circuit topology and the control circuit thereof. The control circuit controls the switch S2 in the BUCK main circuit, to make the output current be a set value, where the set value is controlled by the light source driver. Furthermore, the DC/DC circuit shown in FIG. 3b may be other non-isolated DC/DC converter, such as a Boost circuit or a Buck-Boost circuit, which is not limited here.

FIG. 3c is a second specific implementation based on FIG. 3a. The LED current control circuit is implemented by an isolated Flyback circuit topology and the control circuit thereof. The LED current control circuit may also be other isolated circuits, such as a Forword circuit, a bridge circuit, a push-pull circuit, or an LLC resonant circuit, which is not limited here.

(2) The structure of the LED module includes a constant current circuit and LED lamps of at least two colors which are connected in parallel with the output terminal of the constant current circuit. The LED current control circuit includes the constant current circuit and a control switch connected in parallel with the LED lamps, for controlling the color and/or brightness of each branch of the LED lamps by the current, and the LED current control circuit is controlled by the output signal of the light source driver.

As shown in FIG. 3d, the LED module includes a constant current circuit, the output terminal of the constant current circuit is connected with the series-connected R lamps, G lamps and B lamps, and the control switches Sr1, Sr2 and Sr3 are connected in parallel with the R lamps, G lamps, and B lamps respectively.

The constant current circuit may be a non-isolated DC/DC circuit, such as a Buck circuit, a Boost circuit, or a Buck-Boost circuit; or may be an isolated switching converter circuit, such as a Flyback circuit, a Forword circuit, a bridge circuit, a push-pull circuit, or an LLC resonant circuit; or may be a linear adjusting circuit.

The light source driver respectively outputs control signals to the control switches Sr1, Sr2, Sr3 and the constant current circuit. The control signal may be a pulse signal.

The light source driver may control the constant current circuit to control the amplitude of the current outputted by the constant current circuit, i.e., adjust the total brightness of the LED module; and may control the control switches Sr1, Sr2, Sr3 to control the duty cycle of the current of each branch of the R lamps, G lamps, B lamps, thus the color of the LED lamp module is controlled.

It should be noted that a LED module may include LED lamps of any two or more colors and the corresponding control switches.

FIG. 3e is a specific implementation of FIG. 3d, where the constant current circuit is implemented by a non-isolated Buck circuit topology and the control circuit thereof. FIG. 3f is another specific implementation of FIG. 3d, where the constant current circuit is implemented by a linear adjusting circuit, in which the switch S2 may be a regulator.

(3) The structure of the LED module: each of the LED modules includes a light source driver, LED lamps of one or at least two colors which are connected in parallel with the output terminals of the light source driver, and current limiting circuits connected in series with each branch of the LED lamps. All of the current limiting circuits in a LED module form the LED current control circuit. LED lamps of one color may be or may not be connected in serial with the main circuit.

As shown in FIG. 3g, each LED module includes: a light source driver, LED lamps of one or at least two colors which are connected in parallel with the output terminal of the light source driver, and current limit circuits connected in series with each branch of LED lamps; all of the current limiting circuits in the LED module form an LED current control circuit. LED lamps of one color may be or may not be connected in serial with the main circuit.

W lamps are connected in series with the main circuit, and the light source driver outputs three control signals Iset1, Iset2 and Iset3 for controlling currents of branches of R, G and B lamps respectively, and the adjustment of the color and/or brightness is achieved by controlling the currents of the branches of the three loads.

Referring to FIG. 3g, the current limiting circuit may be a linear adjusting circuit. Taking the current limiting circuit of the R lamp branch as an example, the current limiting circuit includes a current limiting control circuit, a sampling resistor Rs1 and a regulator S1. The current limiting control circuit samples the current I1 of the load branch it locates, compares the sampled signal with a preset value Iset1, and outputs a driving signal to the regulator S1, so as to limit the current of the load branch by adjusting the impedance of the regulator S1.

The light source driver outputs a corresponding control signal to control the current limiting circuit, so as to change the current of each LED branch in the LED module by the current limiting circuit.

Furthermore, in the above embodiments of the invention, since the voltage outputted from the centralized driving module is a voltage containing a chopped voltage, which will affect the followed light source module, a voltage holding circuit may be added between the centralized driving module and the light source module (for example, the LED modules in FIG. 3h). The signal outputted from the voltage holding circuit is a non-pulse DC voltage, therefore the input voltage of the followed light source module is a non-pulse DC voltage after passing through the voltage holding circuit. Thus the normal operation of the followed LED module will not be affected when the centralized driving module outputs the chopped voltage. However, the input voltage of the light source driver should be the voltage that has not pass through the voltage holding circuit. For example, in the circuit shown in FIG. 3h, the output voltage of the centralized driving module passes through the voltage holding circuit so as to provide stable electric power to the LED modules; and the output voltage of the centralized driving module is also inputted to the light source driver directly, so as to ensure that the light source driver can detect the chopped voltage signal, for performing adjusting control of the color and/or brightness of the light source. As shown in FIG. 3i, the voltage holding circuit may be implemented by a diode and a capacitor. FIG. 3i is an implementation structure of FIG. 3a in a case that a voltage holding circuit exists, and the voltage holding circuit may also be added for FIG. 3b-FIG. 3g, the specific structures thereof may be obtained by referring to FIG. 3h and FIG. 3i, and the detailed description is omitted.

Furthermore, the above method for controlling the light source according to the invention also has the following advantages.

Firstly, as shown in FIG. 1, the chopping of the alternating current (AC) voltage may be implemented by turning on and turning off the adjusting switch in FIG. 1, and the chopping of the DC voltage is implemented by the adjusting switch in FIG. 1a. Therefore, the chopping in FIG. 1 is the chopping of AC voltage, the chopped voltage is transferred to the driver in FIG. 1, and the followed light sources are adjusted uniformly by the driver. However, the above method is not applicable for the case that the color and/or brightness of each light source corresponding to a certain driver is required to be adjusted. The method for controlling the light source according to the present invention can be used to adjust the color and/or brightness of different light sources of the same driver.

Moreover, for the circuit structure shown in FIG. 1, different drivers are required to be provided for different light source modules. Therefore, the obtained light source usually has a large volume. However, in the invention, the adjusting processes of multiple light source modules are achieved by a centralized driving module and multiple light source modules, and thus the volume of the light source is decreased and the cost is reduced.

Secondly, in the invention, a pulse square wave may be obtained by chopping, and the frequency of the pulse square wave is feasible in a wide range. The duty cycle of the adjusting switch is the duty cycle of the followed light source module for adjusting the brightness of the light source, so a standardized design is easy to be established in the industry.

Furthermore, compared with the chopping of the AC voltage in the prior art, there are good electromagnetic compatibility at the power grid AC side and high power factor for the method for controlling the light source according to the invention.

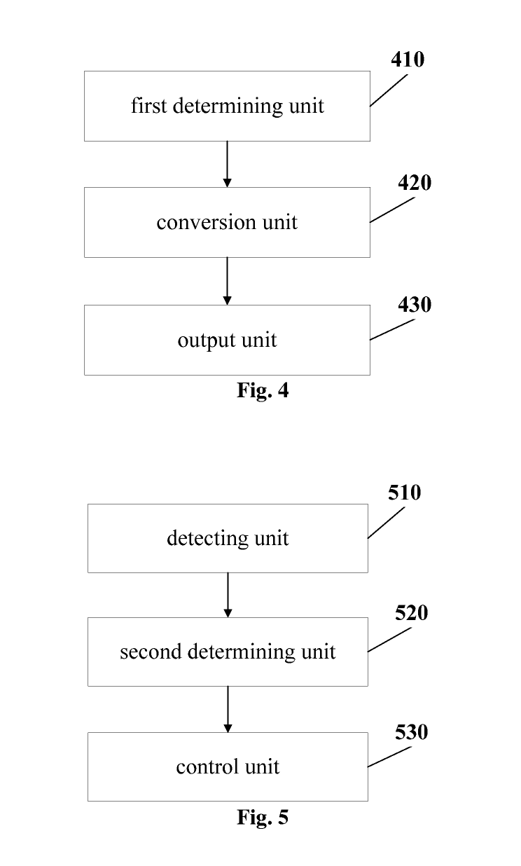

Corresponding to the above-described method for controlling the light source, apparatuses for controlling the light source are also provided by embodiments of the invention, as shown in FIG. 4 and FIG. 5.

FIG. 4 illustrates an apparatus for controlling a light source according to an embodiment of the invention, the apparatus may be used as the adjusting switch controller in the centralized driving module, and includes:
a first determining unit 410, configured to obtain an adjusting signal and determine a light-adjusting item according to the adjusting signal, where the light-adjusting item consists of a value and/or a value range of at least one characteristic parameter of a pulse driving signal;
a conversion unit 420, configured to convert the adjusting signal into the pulse driving signal indicated by the light-adjusting item; and
an output unit 430, configured to control an adjusting switch by the pulse driving signal, to output a voltage containing a chopped voltage that corresponds to the light-adjusting item.

The characteristic parameter includes: duty cycle, frequency, duration of high-level, duration of low-level.

Preferably, the first determining unit 410 may include:
a presetting sub-unit, configured to preset a correspondence relationship between the adjusting signal and the light-adjusting item; and
a searching sub-unit, configured to search the correspondence relationship according to the adjusting signal, to obtain the light-adjusting item corresponding to the adjusting signal.

The conversion unit 420 may be configured to:
convert the adjusting signal into a corresponding pulse driving signal directly according to the light-adjusting item, or
convert the adjusting signal into a DC pulse signal, and convert the DC pulse signal into the corresponding pulse driving signal according to the light-adjusting item.

FIG. 5 is another apparatus for controlling the light source according to an embodiment of the invention, the apparatus may be used as the light source driver in the light source module, and includes:
a detecting unit 510, configured to receive electric energy containing a chopped voltage, and detect a preset characteristic parameter of the chopped voltage;
a second determining unit 520, configured to determine a light-adjusting item according to a value and/or a value range of the characteristic parameter, where the light-adjusting item consists of a value and/or a value range of at least one characteristic parameter of a pulse driving signal;
a control unit 530, configured to determine a light source control strategy according to the light-adjusting item, so as to control the light source as indicated by the light source control strategy.

The control unit 530 may include:
a determining sub-unit, configured to determine the light source control strategy according to the light-adjusting item;
a generating sub-unit, configured to generate a corresponding control signal according to a target current value contained in the light source control strategy; and
a transferring sub-unit, configured to input the control signal to a light source controller, so that the light source controller adjusts, according to the control signal, the current that is outputted from the light source controller itself to each light source, to output the corresponding target current value, thereby achieving the adjustment of the color and/or brightness of the light source.

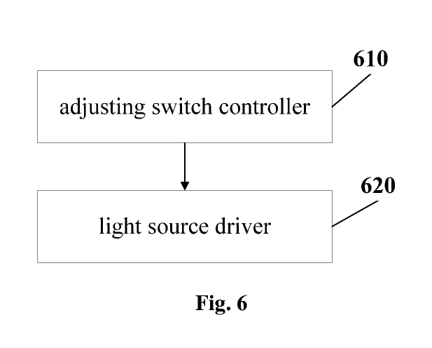

Furthermore, a system for controlling a light source is further provided by an embodiment of the invention, as shown in FIG. 6, the system includes:
an adjusting switch controller 610, configured to acquire an adjusting signal and determine a light-adjusting item according to the adjusting signal, where the light-adjusting item consists of a value and/or a value range of at least one characteristic parameter of a pulse driving signal; convert the adjusting signal into a pulse driving signal indicated by the light-adjusting item; and control an adjusting switch by the pulse driving signal, to output a voltage containing a chopped voltage that corresponds to the light-adjusting item; and
a light source driver 620, configured to receive electric energy containing a chopped voltage and detect a preset characteristic parameter of the chopped voltage; determine a light-adjusting item according to a value and/or a value range of the characteristic parameter, where the light-adjusting item consists of the value and/or the value range of at least one characteristic parameter of the pulse driving signal; and determine a light source control strategy according to the light-adjusting item, so as to control the light source as indicated by the light source control strategy.

In the apparatus and system shown in FIGS. 4-6, at the centralized driving module side, the adjusting switch controller 610 determines the corresponding light-adjusting item according to the adjusting signal, so as to convert the adjusting signal into the pulse driving signal indicated by the light-adjusting item, and the adjusting switch is controlled by the pulse driving signal, so that the centralized driving module outputs a voltage containing the chopped voltage that corresponds to the light-adjusting item, and by providing an instruction of the light-adjusting item to the light source module by the chopped voltage, the light source driver in the light source module controls the color and/or brightness of the light source as indicated by the light-adjusting item. At the light source module side, the light source driver 620 receives the electric energy containing the chopped voltage, detects the preset characteristic parameter of the chopped voltage; determines the light-adjusting item according to the value and/or the value range of the characteristic parameter; determines a light source control strategy according to the light-adjusting item, and thus controls the color and/or brightness of the light source as indicated by the light source control strategy, therefore, the light source driver can identify the light-adjusting item by the chopped voltage, so as to achieve the control of the color and/or brightness of the light source.

It shall be understood by those skilled in the art that the processes of the above methods according to the embodiments can be implemented by a program instructing related hardware. The program may be stored in a readable medium, and the program, when executed, may execute the corresponding steps of the above methods. The storage medium may be ROM/RAM, a magnetic disk, an optical disc, etc.

Preferable embodiments of the present invention are described above. It should be noted that those skilled in the art can make modifications and alternations without deviation from the principle of the present invention, and the modifications and alternations shall fall within the scope of the present invention.

1. A method for controlling a light source, comprising:
acquiring an adjusting signal and determining a light-adjusting item according to the adjusting signal, wherein the light-adjusting item consists of a value and/or a value range of at least one characteristic parameter of a pulse driving signal;
converting the adjusting signal into the pulse driving signal indicated by the light-adjusting item; and
controlling an adjusting switch by the pulse driving signal, to output a voltage containing a chopped voltage that corresponds to the light-adjusting item, thereby transferring adjustment information of color and/or brightness of the light source by means of the voltage containing the chopped voltage.

2. The method according to claim 1, wherein the characteristic parameter comprises: duty cycle, frequency, duration of high-level, duration of low-level.

3. The method according to claim 1, wherein the determining a light-adjusting item according to the adjusting signal comprises:
presetting a correspondence relationship between the adjusting signal and the light-adjusting item; and
searching the correspondence relationship according to the adjusting signal to obtain the light-adjusting item corresponding to the adjusting signal.

4. The method according to claim 1, wherein the converting the adjusting signal into the pulse driving signal indicated by the light-adjusting item comprises:
converting the adjusting signal into the pulse driving signal indicated by the light-adjusting item directly according to the light-adjusting item; or
converting the adjusting signal into a direct current pulse signal, and converting the direct current pulse signal into the pulse driving signal indicated by the light-adjusting item.

5. The method according to claim 1, wherein the controlling an adjusting switch comprises:
performing chopping control on the adjusting switch during a time period t1 within a time period t2 since the adjusting signal is acquired, wherein t1 is smaller than or equal to t2, t1 is greater than or equal to 1/f, f is switching frequency of the adjusting switch, and t2 is a time interval between acquiring the current adjusting signal and acquiring the next adjusting signal.

6. The method according to claim 5, the method further comprises:
controlling the adjusting switch to be in a turn-on state during the rest of the time period t2, other than the time period t1, since the adjusting signal is acquired.

7. A method for controlling a light source, comprising:
receiving electric energy containing a chopped voltage, and detecting a preset characteristic parameter of the chopped voltage;
determining a light-adjusting item according to a value and/or a value range of the characteristic parameter, wherein the light-adjusting item consists of a value and/or a value range of at least one characteristic parameter of a pulse driving signal; and
determining a light source control strategy according to the light-adjusting item, so as to control color and/or brightness of the light source as indicated by the light source control strategy.

8. The method according to claim 7, wherein the preset characteristic parameter is the same as the characteristic parameter in the light-adjusting item.

9. The method according to claim 7, wherein the determining a light source control strategy according to the light-adjusting item so as to control color and/or brightness of the light source as indicated by the light source control strategy comprises:
determining the light source control strategy according to the light-adjusting item;
generating a corresponding control signal according to a target current value contained in the light source control strategy; and
inputting the control signal to a light source controller, so that the light source controller adjusts, according to the control signal, current that is outputted from the light source controller itself to each light source, to output a corresponding target current value, thereby achieving the adjustment of the color and/or brightness of the light source.

10-15. (canceled)

16. A system for controlling a light source, comprising:
an adjusting switch controller, configured to acquire an adjusting signal and determine a light-adjusting item according to the adjusting signal, wherein the light-adjusting item consists of a value and/or a value range of at least one characteristic parameter of a pulse driving signal; convert the adjusting signal into a pulse driving signal indicated by the light-adjusting item; and control an adjusting switch by the pulse driving signal, to output a voltage containing a chopped voltage that corresponds to the light-adjusting item, thereby transferring adjustment information of color and/or brightness of the light source by means of the voltage containing the chopped voltage; and
a light source driver, configured to receive electric energy containing the chopped voltage and detect a preset characteristic parameter of the chopped voltage; determine the light-adjusting item according to the value and/or the value range of the characteristic parameter, wherein the light-adjusting item consists of the value and/or the value range of at least one characteristic parameter of the pulse driving signal; determine a light source control strategy according to the light-adjusting item, so as to control the color and/or brightness of the light source as indicated by the light source control strategy.

17. The method according to claim 2, wherein the determining a light-adjusting item according to the adjusting signal comprises:
presetting a correspondence relationship between the adjusting signal and the light-adjusting item; and
searching the correspondence relationship according to the adjusting signal to obtain the light-adjusting item corresponding to the adjusting signal.

18. The method according to claim 2, wherein the converting the adjusting signal into the pulse driving signal indicated by the light-adjusting item comprises:
converting the adjusting signal into the pulse driving signal indicated by the light-adjusting item directly according to the light-adjusting item; or
converting the adjusting signal into a direct current pulse signal, and converting the direct current pulse signal into the pulse driving signal indicated by the light-adjusting item.

19. The method according to claim 3, wherein the controlling an adjusting switch comprises:
performing chopping control on the adjusting switch during a time period t1 within a time period t2 since the adjusting signal is acquired, wherein t1 is smaller than or equal to t2, t1 is greater than or equal to 1/f, f is switching frequency of the adjusting switch, and t2 is a time interval between acquiring the current adjusting signal and acquiring the next adjusting signal.

20. The method according to claim 4, wherein the controlling an adjusting switch comprises:
performing chopping control on the adjusting switch during a time period t1 within a time period t2 since the adjusting signal is acquired, wherein t1 is smaller than or equal to t2, t1 is greater than or equal to 1/f, f is switching frequency of the adjusting switch, and t2 is a time interval between acquiring the current adjusting signal and acquiring the next adjusting signal.

21. The method according to claim 8, wherein the determining a light source control strategy according to the light-adjusting item so as to control color and/or brightness of the light source as indicated by the light source control strategy comprises:
determining the light source control strategy according to the light-adjusting item;
generating a corresponding control signal according to a target current value contained in the light source control strategy; and
inputting the control signal to a light source controller, so that the light source controller adjusts, according to the control signal, current that is outputted from the light source controller itself to each light source, to output a corresponding target current value, thereby achieving the adjustment of the color and/or brightness of the light source.
